(19) United States
(12) Patent Application Publication
(10) Pub. No.: US 2011/0143120 A1
(43) Pub. Date: Jun. 16, 2011

(54) AMINO-FORMALDEHYDE RESINS, APPLICATIONS THEREOF AND ARTICLES MADE THEREFROM

(75) Inventors: John D. Slayter, Alexandria, LA (US); Jeff Swartzentruber, Goshen, KY (US)

(73) Assignee: Hexion Specialty Chemicals, Inc.

(21) Appl. No.: 12/963,050

(22) Filed: Dec. 8, 2010

Related U.S. Application Data
(60) Provisional application No. 61/286,272, filed on Dec. 14, 2009.

(51) Int. Cl. B32B 21/04; C08L 61/24

(52) U.S. Cl. 428/292.4; 525/515; 524/542; 524/13

(57) ABSTRACT

Amino-formaldehyde resins and methods for making amino-formaldehyde resins are provided herein. In one embodiment, the amino-formaldehyde resins are blends of at least a first amino-formaldehyde resin having a first molar ratio of constituents and at least a second amino-formaldehyde resin having a second molar ratio of constituents different than the first molar ratio of constituents. The first amino-formaldehyde resin may be a melamine-urea-formaldehyde resin. The second amino-formaldehyde resin may be a urea-formaldehyde resin, which may optionally include melamine. The blend of the amino-formaldehyde resins may be used in the manufacture of articles, such as composite boards.

### RELATED APPLICATION DATA

This application claims benefit to U.S. Provisional Application No. 61/286,272, filed Dec. 14, 2009, of which the entire contents of the application are incorporated by reference herein.

### BACKGROUND OF THE INVENTION

1. Field of the Invention

The present invention relates to amino-formaldehyde resins, application of the resins, and manufacture of the articles from the resins. In particular, the amino-formaldehyde resins are blends of at least a first molar ratio amino-formaldehyde resin component and at least a second molar ratio amino-formaldehyde resin component, which may optionally include a second amino compound, having a different molar ratio than the first molar ratio amino-formaldehyde resin component.

2. Background of the Art

In the wood products industry, there is a growing concern over formaldehyde emissions. As a result many different reduced formaldehyde or non-formaldehyde adhesive systems have emerged. These systems generally include: (i) changing the formulation of the formaldehyde adhesive resin; (ii) adding formaldehyde-scavenging materials directly to the formaldehyde resin; (iii) separately adding formaldehyde-scavenging materials to the wood furnish; (iv) treating panels after manufacture either with a formaldehyde scavenger or by applying coatings or laminates; and (v) changing to an entirely different adhesive system.

In conventional formulations, lowering the formaldehyde ratios is not without problems. For example, lowering the mole ratio of urea formaldehyde (UF) resins increases cure time and reduces the bond strength and physical properties of composite boards due to a reduction in the extent of cross-linking during curing.

Melamine urea formaldehyde (MUF) resins can provide improved cross-linking and lower formaldehyde emissions at lower formaldehyde ratios [F/(U+M)] without hindering mechanical and physical properties of boards. However, the melamine content must be increased to retain the physical properties of boards at the lowest formaldehyde to urea and melamine ratios.

Ultra low molar ratio scavenger resins are used because they allow for composite panel manufacturers to customize their resin system to meet both formaldehyde emissions and physical properties, but the very high levels of scavenger resins that are required have a negative impact on physical properties.

MUF resins can be used in conjunction with ultra low molar ratio scavenger resins to reduce board emissions. However, scavenger resins without melamine fortification subtract from the melamine content of the mix, thus reducing melamine content as the molar ratio is reduced, which is opposite of the desired outcome. Additionally, ultra low formulations of MUF resin as a scavenger resin have significantly reduced storage stability compared to conventional formulations.

It would be desirable in the art of making amino-formaldehyde resins to decrease the amount of formaldehyde released over time by the resins. It would also be desirable to replace the use of scavenger resins to allow panel manufacturers to retain the flexibility of such resins, but with out the detrimental effects on physical properties.

### SUMMARY OF THE INVENTION

In one aspect, the invention is a blend of two or more amino-formaldehyde resins with at least a first molar ratio amino-formaldehyde resin component and at least a second molar ratio amino-formaldehyde resin component, which may optionally include a second amino compound, having a different molar ratio than the first molar ratio amino-formaldehyde resin component.

In another aspect, the invention is a unique resin system of two amino-formaldehyde resins using a formulation comprising formaldehyde, urea, and melamine. One resin may have a ratio of formaldehyde to urea and melamine of about 0.60 to about 0.85, and the other resin may have a ratio of formaldehyde to urea and melamine of about 1.05 to about 1.40.

In another aspect, the invention is a unique resin system of two amino-formaldehyde resins using a formulation comprising formaldehyde, urea and melamine where the lower molar ratio component is the primary or majority component of a blend with the higher molar ratio secondary or minority component at rates of about 99 to about 30 parts low molar ratio to about 70 to about 1 parts high molar ratio component In another aspect, the invention is a unique resin system of two amino-formaldehyde component resins each resin comprising formaldehyde and urea, and optionally, melamine, where one or both component resins comprise melamine and the melamine content of the mixture may be from about 0.2 to about 7 parts based on the weight of liquid resin.

In another aspect, the invention is an article of manufacture whereby the two component amino-formaldehyde resins comprising of formulations of formaldehyde, urea and melamine are mixed immediately prior to application to wood particles or fibers in the production of particleboard or medium density fiberboard so that the desired combined ratio of formaldehyde to urea and melamine is in the range from about 0.60 to about 1.24 to allow the panel manufacture to optimize the desired panel formaldehyde emissions and physical properties.

In another aspect, a resin system is provided including a first amino-formaldehyde resin comprising formaldehyde, urea, and melamine and having a first molar ratio of formaldehyde to urea and melamine, and a second amino-formaldehyde resin comprising at least formaldehyde and urea and having a second molar ratio of formaldehyde to urea, wherein the second molar ratio is greater than the first molar ratio and the combined molar ratio of formaldehyde to urea and melamine of the resin system comprises from about 0.6 to about 1.24.

In another aspect, an article of manufacture is provided, including a first amino-formaldehyde resin comprising formaldehyde, urea, and melamine and having a first molar ratio of formaldehyde to urea and melamine, a second amino-formaldehyde resin comprising at least formaldehyde and urea and having a second molar ratio of formaldehyde to urea, wherein the second molar ratio is greater than the first molar ratio and the combined molar ratio of formaldehyde to urea and melamine of the resin system comprises from about 0.6 to about 1.24, and a cellulosic material component.

In another aspect, a process for forming a resin system is provided, including providing a first amino-formaldehyde resin comprising formaldehyde, urea, and melamine to a mixing apparatus, providing a second amino-formaldehyde resin comprising at least formaldehyde and urea to the mixing apparatus, wherein the second molar ratio is greater than the first molar ratio, and mixing the first amino-formaldehyde resin and the second amino-formaldehyde resin, wherein a combined molar ratio of formaldehyde to urea and melamine of the resin system comprises from about 0.6 to about 1.24.

### DETAILED DESCRIPTION OF FIGURES

The following is a brief description of figures wherein like numbering indicates like elements.

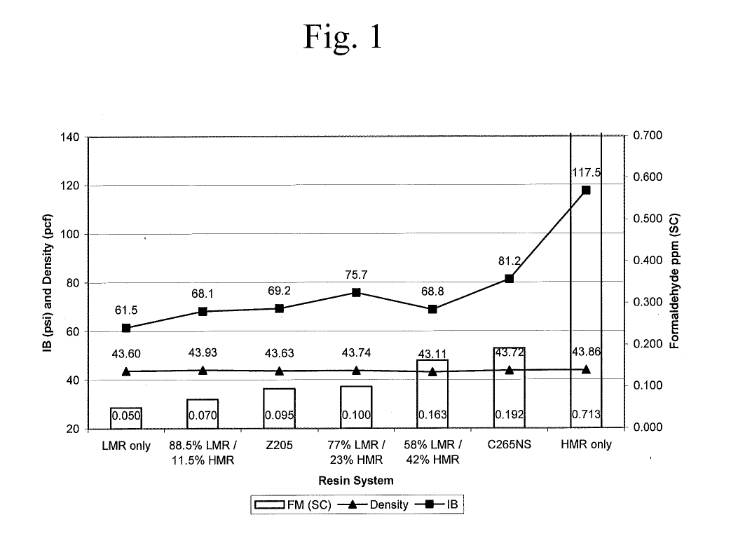

FIG. 1 is a Bar Graph showing IB (psi) and Density (pcf) of Resins Prepared in Example 2—Long Cycle Only.

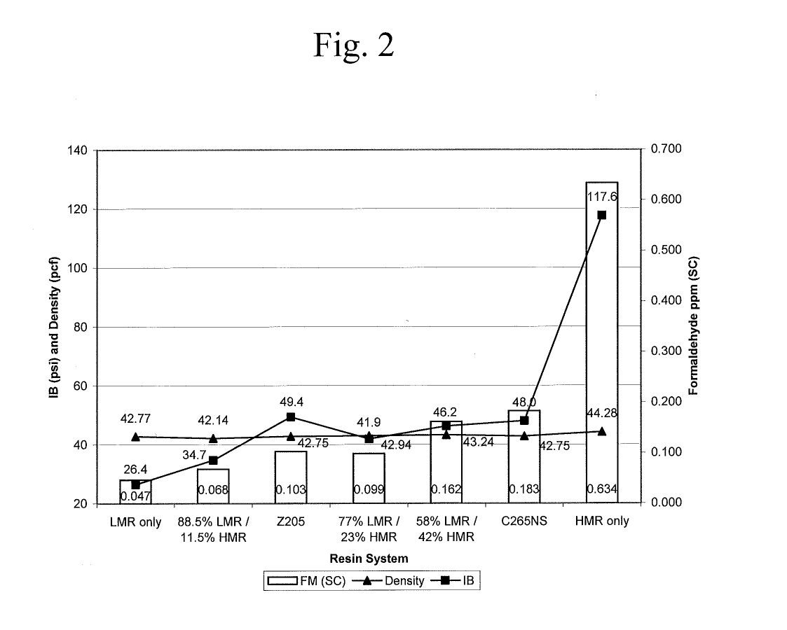

FIG. 2 is a Bar Graph showing IB (psi) and Density (pcf) of Resins Prepared in Example 2—Short Cycle Only.

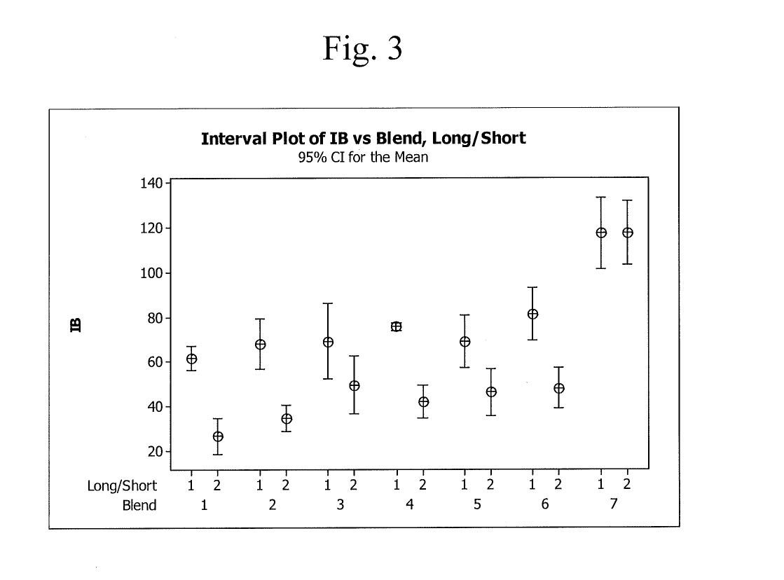

FIG. 3 is an Interval Plot of IB vs. Blend Long/Short Cycles.

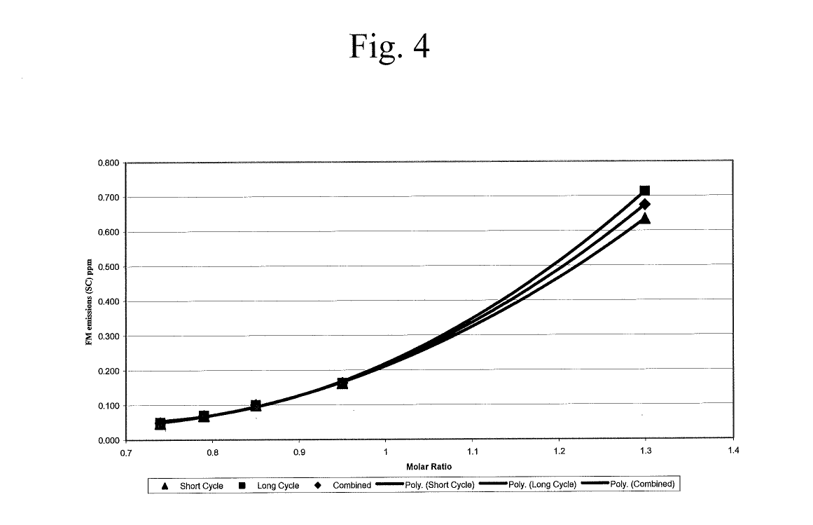

FIG. 4 is a Graph showing FM emissions (SC) ppm as a function of Molar Ratio.

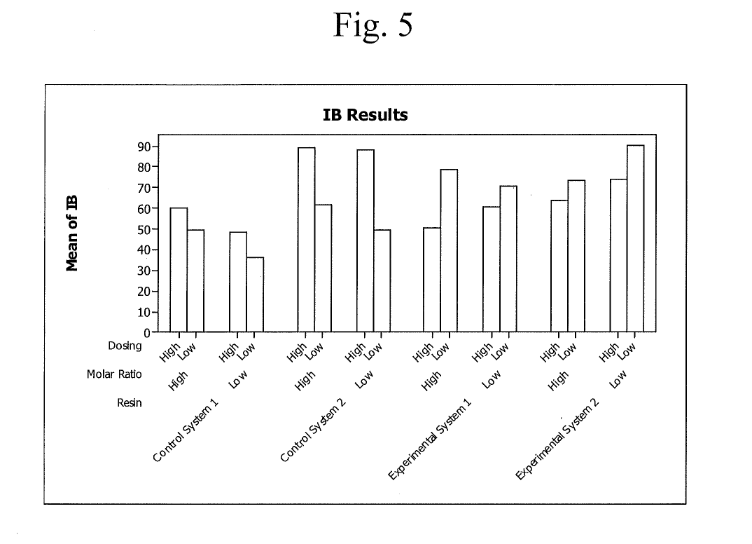

FIG. 5 is a Graph showing mean IB results (psi) vs. Molar Ratio of experimental and control systems.

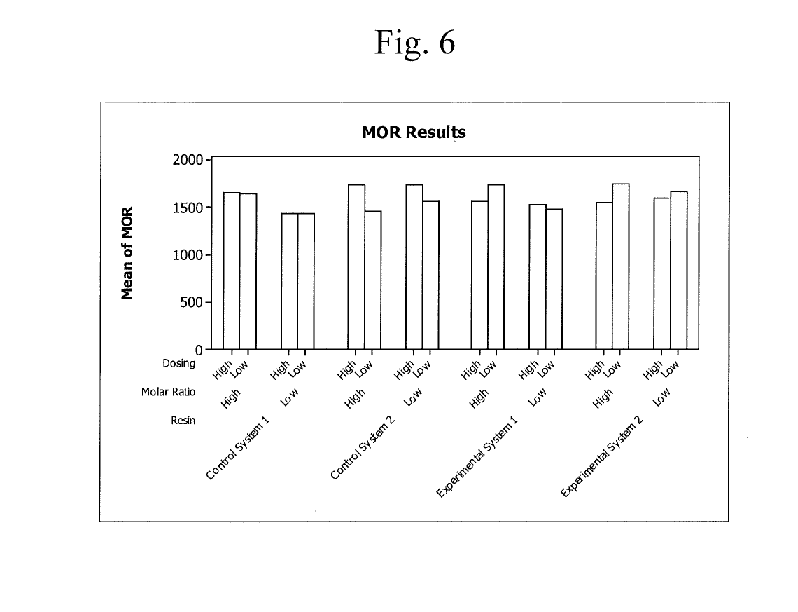

FIG. 6 is a Graph showing mean MOR results (psi) vs. Molar Ratio of experimental and control systems.

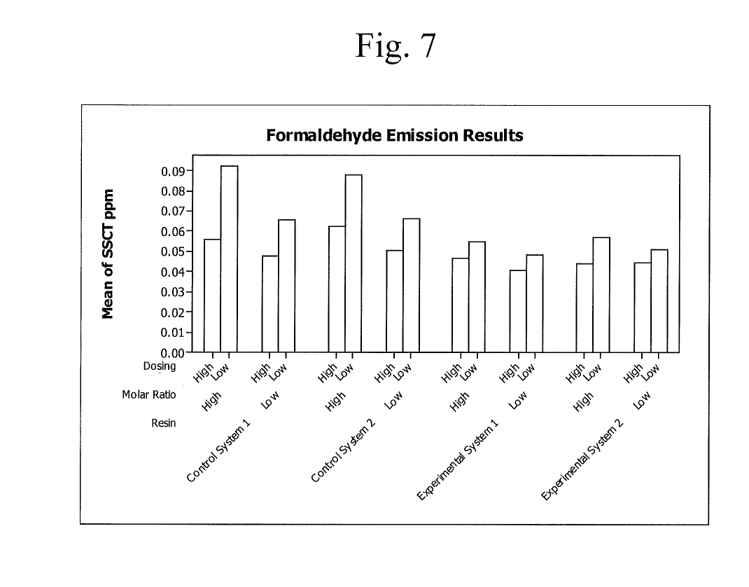

FIG. 7 is a Graph showing mean MOR results (psi) vs. Molar Ratio of experimental and control systems.

### DESCRIPTION OF THE PREFERRED EMBODIMENTS

In one embodiment of the invention, the resin system is a blend of at least two amino-formaldehyde resins. The resin system is formulated to reduce the release of formaldehyde over time in articles manufactured from the resins. Each of the at least two amino-formaldehyde resins may have a different molar ratio of amino compounds to formaldehyde. Each of the resin systems may independently be a melamine, urea, and formaldehyde (MUF) resin or a urea and formaldehyde (UF) resin.

In another embodiment, the resin system is prepared from a blend of at least one melamine, urea, and formaldehyde (MUF) resin and at least one urea and formaldehyde (UF) resin that may optionally include melamine having different molar ratios of amino compounds to formaldehyde. In another embodiment, each resin in the blend of the at least two amino-formaldehyde resins is capable of being used as the only binder system to prepare particle board (PB) or medium density fiberboard (MDF). In another embodiment, the resin system of the invention does not contain an ultra low molar ratio based resin (i.e. a “scavenger resin”) which, by itself, is incapable of being used as a binder system to prepare PB or MDF.

For the purposes of the disclosure an amino-formaldehyde resin is one prepared with formaldehyde and at least one amino compound, such as urea, melamine, and derivatives and combinations thereof. Examples of the at least one amino compound include urea or melamine, or urea and melamine. In the art, urea formaldehyde resins are often referred to as UF resins, melamine urea formaldehyde resins are often referred to as MUF resins, and melamine formaldehyde resins are often referred to as MF resins.

In some embodiments, the amino-formaldehyde resins of the disclosure may be prepared using formalin which is, for the purposes of this disclosure, formaldehyde dissolved in water. While any concentration of formaldehyde known to be useful to those skilled in the art of preparing resins to be useful may be used in the formalin, a weight concentration of from about 44 to about 55 percent may be used because of its wide availability. In one embodiment, the formalin will have a concentration of about 35 weight percent. In another embodiment, the formalin will have a concentration of about 55 weight percent.

In other embodiments, the amino-formaldehyde resins of the disclosure that include urea may be prepared using formaldehyde in the form of a urea formaldehyde concentrate. This concentrate may include, for example, about 60% formaldehyde and about 25% urea. When higher concentrations of formaldehyde are used, it may be desirable to insure that the formation of paraformaldehyde is avoided.

The amino-formaldehyde resins of the disclosure may be made with urea in some embodiments. The urea used in resin manufacture is handled as white solid granules and the urea used with some embodiments of the invention may have a purity of about 98 percent. The urea useful with the method of the disclosure may be any that is known to be useful to those of ordinary skill in the art of preparing amino-formaldehyde resins.

Some of the embodiments of the amino-formaldehyde resins of the disclosure are prepared using melamine. The melamine grade may be any that is known to be useful to those of ordinary skill in the art of preparing amino-formaldehyde resins. For example, the melamine used with some embodiments of the invention may have a purity of about 99 percent. In some embodiments, the melamine may have a particle size small enough to ensure quick and complete dissolution. For example, in one such embodiment, the melamine may have a particle size of from about 50 to about 400 microns (μm).

In one embodiment of the invention, the amino-formaldehyde resin is a blend of at least one first molar ratio amino-formaldehyde resin component and at least one second molar ratio amino-formaldehyde resin component having a second molar ratio greater than the first molar ratio. The first molar ratio amino-formaldehyde resin component may be referred to as the low molar ratio component (LMR Component) and the second molar ratio amino-formaldehyde resin component may be referred to as the high molar ratio component (HMR Component). For purposes herein, molar ratios are expressed as moles of formaldehyde (F) divided by the sum of the moles of the amino component, for example, moles of urea (U) and moles of melamine (M), [F/(M+U)]. Alternatively, in the absence of melamine in one of the resin component, the molar ratios are expressed as moles of formaldehyde divided by the moles of urea [F/U]. The first molar ratio amino-formaldehyde resin component may comprise a melamine urea formaldehyde (MUF) resin component and the second molar ratio amino-formaldehyde resin component may comprise an urea formaldehyde (UF) resin component. The second molar ratio amino-formaldehyde resin component may optionally include melamine, which may be referred to as a second molar ratio MUF resin component.

In the first molar ratio amino-formaldehyde resin component, such as a MUF resin, the molar ratio ranges may comprise from about 0.6 to about 0.85, such as from about 0.65 to about 0.8, for example, from about 0.70 to about 0.75. The first molar ratio amino-formaldehyde resin component may comprise melamine from about 0.75 wt. % to about 7 wt. % based on the weight of the resin, such as about 0.75 wt. % to about 4 wt. % based on the weight of the resin, for example, from about 1 wt. % to about 3 wt. % based on the weight of the resin.

In the second molar ratio amino-formaldehyde resin component, such as an UF resin, the molar ratio ranges from about 1.05 to about 1.4, such as from about 1.1 to about 1.4, for example, from about 1.1 to about 1.3, with or without the presence of melamine. The optional second amino compound, melamine, may comprise from about 0 wt. % to about 7 wt. % based on the weight of the resin, such as about 0 wt. % to about 4 wt. % based on the weight of the resin, for example, from about 1 wt. % to about 3 wt. % based on the weight of the resin.

The first molar ratio amino-formaldehyde resin component (LMR Component) and second molar ratio amino-formaldehyde resin component (HMR Component) may be combined in a blend of about 99 to about 30 parts (composition wt. %) first molar ratio amino-formaldehyde resin component (LMR Component) as the primary adhesive component and about 70 to about 1 parts second molar ratio amino-formaldehyde resin component (HMR Component) as the minority adhesive component. In one embodiment, the first molar ratio amino-formaldehyde resin component (LMR Component) comprises about 88.5 parts and the second molar ratio amino-formaldehyde resin component (HMR Component) comprises about 12.5 parts, such as from a first molar ratio amino-formaldehyde resin component (LMR Component) of about 77 parts to about 23 parts of the second molar ratio amino-formaldehyde resin component (HMR Component), for example, from a first molar ratio amino-formaldehyde resin component (LMR Component) of about 55 parts to about 45 parts of the second molar ratio amino-formaldehyde resin component (HMR Component). Alternatively, the second molar ratio amino-formaldehyde resin component (HMR Component) may comprise 0 parts in the resin to be used to form the articles described herein.

The combined molar ratio of the two component amino-formaldehyde resins may be in the range of about 0.60 to about 1.24, such as from about 0.60 to about 1.16 to allow the panel manufacture to optimize the desired panel formaldehyde emissions and physical properties. “Parts” and “parts based on weight” as disclosed herein refer to weight percent (wt. %).

The melamine content of the combined first molar ratio amino-formaldehyde resin component (LMR Component) and the second molar ratio amino-formaldehyde resin component (HMR Component) may be from about 0.2 parts (wt. %) to about 7 parts (wt. %), such as from about 0.35 wt. % to about 5 wt. %, for example, from about 0.75 wt. % to about 2 wt. %, based on the weight of the liquid resin.

The reaction mixture may form a composition having a solids content from about 55 wt. % to about 72 wt. %, such as from about 59 wt. % to about 65 wt. %.

In one embodiment, the first molar ratio amino-formaldehyde resin component (LMR Component) and second molar ratio amino-formaldehyde resin component (HMR Component) may be formed by methods familiar with someone in the art of making UF and MUF resins, including the use of typical acids and bases, including but not restricting, triethanolamine, aminotriethyl, sodium borate, sodium formate, trisodium phosphate, ammonia, sodium bicarbonate, ammonium sulfate, boric acid, formic acid, sulfuric acid, hydrochloric acid and the like.

The molar ratio of ultra low molar ratio scavenging resins is from 0.55 to 0.33.

### Applications

The amino-formaldehyde resins of the disclosure are particularly useful in preparing articles of manufacture where the amino-formaldehyde resins function to bind or to adhere substrates together. For example, in one embodiment of the invention, the substrates may be in a form selected from the group consisting of cellulosic materials, such as cellulosic-particles, -strands, -fibers, -veneers, and mixtures thereof. One example of suitable cellulosic materials includes wood particles or fibers.

For example, the resin blends of the disclosure may be used as the primary binders used for interior-grade wood composite boards such as particleboard (PB), hardwood plywood (HWP), and medium density fiberboard (MDF). The boards may be a single layer board or a multi-layer boards. One example of the multi-layer board includes a core panel and at least one (usually two) surface layers disposed on the core layer. The articles of manufacture may be prepared using any method known to be useful to those of ordinary skill in the art. For example, particleboard may be prepared using the methods disclosed in U.S. Pat. No. 4,482,699 to Williams, the entire contents of which is incorporated herein by reference.

When the resin system as described herein is contacted with the cellulosic material to form a panel, the resin system comprises from about 5 wt. % to about 20 wt. % of the panel, such as from about 7 wt. % to about 14 wt. %, for example, from about 8 wt. % to about 12 wt. %.

In a multi-layer board, the different layers of the multi-layer system may have the same or different molar ratios. In one embodiment, the multi-layer may include a core layer and at least one surface layer. The core layer may have a resin system ratio from about 0.60 to about 1.24 derived from a ratio of the first molar ratio amino-formaldehyde resin component (LMR Component) to the second molar ratio amino-formaldehyde resin component (HMR Component) from about 99:1 to about 30:70. The surface layer may have a resin system ratio from about 0.60 to about 1.24 derived from a ratio of the first molar ratio amino-formaldehyde resin component (LMR Component) to the second molar ratio amino-formaldehyde resin component (HMR Component) from about 99:1 to about 30:70. In one embodiment of the multi-layer board the core panel resin system amino-formaldehyde resin component molar ratio may be greater than the surface panel resin system amino-formaldehyde resin component molar ratio.

In one embodiment of the invention each panel may have a free formaldehyde emission from about 0.02 ppm to about 0.3 ppm using ASTM E1333 or D6007-02 (2008) at a resin system molar ratio from about 0.60 to about 1.24. Each panel may have an internal bond (IB) property of about 15 psi or greater, such as from about 15 psi to about 200 psi. Each panel may have a modulus of rupture (MOR) of about 435 psi or greater, such as from about 435 psi to about 4000 psi. The panels manufactured from the resins in this invention will meet the desired manufacturing parameters, attributes and properties of the manufacturer with regard to manufacturing speed, attainment of applicable standards both internal to the manufacturer and external to certifying agencies.

Further, the amino-formaldehyde resin blends of the disclosure may be prepared including additives useful for their final applications. For example, in one embodiment, the resin blends may include a mold release agent. Other additives useful with the amino-formaldehyde resin blends as described herein include buffering agents, internal catalysts, tack modifiers, flow modifiers, and fire retardants. These additives are familiar to one skilled in the art of making UF and MUF resins.

The amino-formaldehyde resin blends of this disclosure are intended to be mixed as close as possible to the point of application to the suitable cellulosic materials used to manufacture the panels. This may be done through the use of mix tanks, in-line mixers, separate application nozzles or other means. Application methods after blending to the cellulosic materials will vary but includes mechanical blenders, spreaders, blowline blending and the like, which are familiar to the art of manufacturing composite panels.

### EXAMPLES

The following examples are provided to illustrate the present invention. The examples are not intended to limit the scope of the present invention and they should not be so interpreted. Please note in the examples below, that the viscosity is measure in Gardner viscosities.

### Example 1

LMR and HMR Components resins were prepared per the formulations set forth in Tables 1 and 2 below.

A low molar ratio (LMR1) melamine-urea-formaldehyde (MUF) resin composition was prepared using the constituents in Table 1 as described below. The reaction mixture was initiated by (1) mixing formaldehyde water and triethanolamine (TEA) at an initial temperature and adjusting the pH as indicated to a first pH. To this reaction mixture, (2) urea was added and the reaction mixture was heated to a second temperature and held for a desired time. The reaction mixture (3) may be adjusted to a second pH with 10% formic acid as needed. This mixture was held at the second temperature until a first viscosity was reached. The reaction mixture (4) was cooled to a third temperature and the pH adjusted to a third pH as needed. Melamine and urea (5) were then added and the mixture held at the third temperature until a second viscosity was reached. The pH (6) is adjusted to a fourth pH and then cooled to a fourth temperature. Urea (7) was added and the mixture cooled to the end temperature and held for a desired period of time. Then the mixture was adjusted to the final pH range and cooled to room temperature.

The LMR1 resin composition was obtained and tested. The composition had an observed pH of about 8.35, a refractive index of about 1.475, a specific gravity of about 1.277, a viscosity of about 129 cps, and an oven solids of about 66.64%. The resin composition had a molar ratio of about 0.74 F/(U+M) with a melamine content of about 3 wt. %.

TABLE 1
LMR1 Component Formulation

| | | | | | Time or |
|---|---|---|---|---|---|
| Step | Component | Quantity % | Temperature | pH | Gardner |
| 1 | FM (52%) | 39.81 | 40-60° C. | 7.4-8.0 | |
| | TEA | 0.050 | | | |
| | Water | 2.070 | | | |
| 2 | Urea | 17.250 | 97-102° C. | | 5 minutes |
| 3 | 10% formic | 0.270 | 97-102° C. | 5.0-5.4 | “H” |
| 4 | NaOH (25%) | 0.030 | 75-85° C. | 6.7-7.3 | |
| 5 | Melamine | 3.000 | | | |
| 6 | Urea | 2.020 | 75-85° C. | 6.7-8.3 | “P” |
| 7 | Borax | 0.050 | 70-80° C. | 8.0-8.4 | |
| 8 | Urea | 35.440 | 40-45° C. | 8.0-8.4 | 20 minutes |

A high molar ratio (HMR1) melamine-urea-formaldehyde (MUF) resin composition was prepared using the constituents in Table 2 as described below. The reaction mixture was initiated by (1) mixing formaldehyde with triethanolamine at an initial temperature and adjusting to an initial pH as needed. To this reaction mixture, melamine and urea (2) were added and the mixture heated to a second temperature and held for a period of time. The pH (3) was adjusted to a second pH with 10% formic acid and held at the second temperature until a first viscosity was reached. The pH (4) was adjusted to a third pH with 25% sodium hydroxide as needed and cooled to a third temperature. Urea (5) was added and the mixture held at the third temperature until a second viscosity was reached. The pH (6) was adjusted as needed and water was removed under vacuum while the mixture cooled to a fourth temperature. Urea (7) was added and the mixture cooled to a fifth temperature and held 20 minutes. The pH was adjusted as needed and cooled to room temperature.

The HMR1 resin composition was obtained and tested. The composition had an observed pH of about 8.12, a refractive index of about 1.477, a specific gravity of about 1.291, a viscosity of about 187 cps, and an oven solids of about 66.48%. The HMR1 resin composition had a molar ratio of about 1.3 F/(U+M) with a melamine content of about 3 wt. %. A combined molar ratio for the LMR1 and HMR1 resin compositions is about 0.79 at 88.5% LMR and 11.5% HMR.

TABLE 2
HMR1 Component Formulation

| | | | | | Time or |
|---|---|---|---|---|---|
| Step | Component | Quantity % | Temperature | pH | Gardner |
| 1 | FM (52%) | 58.250 | 40-60° C. | 7.4-8.0 | |
| | TEA | 0.050 | | | |
| 2 | Melamine | 3.000 | | | |
| | Urea | 14.660 | 97-102° C. | | 5 minutes |
| 3 | 10% formic | 0.153 | 97-102° C. | 5.4-5.8 | “C” |
| 4 | NaOH (25%) | 0.030 | 75-85° C. | 6.3-6.9 | |
| 5 | Urea | 7.950 | | | “E+” |
| 6 | Borax | 0.050 | | 7.4-8.0 | |
| | −Vacuum | −6.661 | 65° C. | | |
| | Dist | | | | |
| 7 | Urea | 22.500 | 40-45° C. | 8.0-8.4 | 20 minutes |

Properties of the LMR and HMR Components are set forth in Table 3 below.

TABLE 3
LMR and HMR Component Resin Properties

| Resin | LMR1 | HMR1 |
|---|---|---|
| pH | 8.35 | 8.12 |
| Viscosity (cps) | 129 | 187 |
| Refractive Index | 1.4750 | 1.4772 |
| Specific Gravity | 1.277 | 1.291 |
| 105° C. Oven Solids | 66.64% | 66.48% |

### Example 2

LMR and HMR Components resins were prepared per the formulations set forth in Tables 4 and 5 below.

A low molar ratio (LMR2) melamine-urea-formaldehyde (MUF) resin composition was prepared using the constituents in Table 4 as described below. The reaction mixture was initiated by (1) mixing formaldehyde with triethanolamine and water at a first temperature, and adjusting to the pH as needed to a first pH. To this reaction mixture, melamine and urea (2) were added and the mixture heated to the second temperature and held for a desired period of time. The pH (3) was adjusted with 10% formic acid to a second pH level and held at the second temperature until a desired first viscosity was reached. The pH (4) was adjusted to a third pH as needed and cooled to a third temperature. Urea (5) was added and the reaction mixture held at the third temperature until a desired second viscosity was reached. A pH adjusting agent, urea and water (6) was added while the mixture cooled to a fifth temperature and held for the indicated time. Urea (7) was added with sodium chloride and sodium sulfate and the mixture cooled to a sixth temperature and held 20 minutes. The pH was adjusted as needed and cooled to room temperature.

The LMR2 resin composition was obtained and tested. The composition had an observed pH of about 8.1, a refractive index of about 1.4615, a specific gravity of about 1.262, a viscosity of about 62 cps, and an oven solids of about 60.96%. The resin composition had a molar ratio of about 1.3 F/(U+M) with a melamine content of about 2.77 wt. %.

TABLE 4
LMR2 Component Formulation

| | | | | | Time or |
|---|---|---|---|---|---|
| Step | Component | Quantity % | Temperature | pH | Gardner |
| 1 | FM (52%) | 34.950 | | | |
| | TEA | 0.50 | | | |
| | Water | 3.330 | 40-60° C. | 7.4-8.0 | |
| 2 | Melamine | 2.770 | | | |
| | Urea | 8.390 | 97-102° C. | | 5 minutes |
| 3 | 30% formic | 0.060 | | | |
| | Water | 0.120 | 97-102° C. | 4.9-5.3 | “B” |
| 4 | NaOH (25%) | 0.040 | 75-85° C. | 6.7-7.1 | |
| 5 | Urea | 7.640 | | | “L” |
| | Borax | 0.050 | | | |
| | Water | 7.730 | | | |
| 6 | Urea | 6.750 | 60-65° C. | | |
| 7 | Urea | 25.120 | | | 20 minutes |
| | Salt | 2.000 | | | |
| | SodSul | 1.000 | 40-45° C. | 7.9-8.3 | 20 minutes |

A high molar ratio (HMR2) melamine-urea-formaldehyde (MUF) resin composition was prepared using the constituents in Table 5 as described below. The reaction mixture was initiated by (1) mixing formaldehyde with triethanolamine and water at a first temperature, and adjusting to the pH as needed to a first pH. To this reaction mixture, melamine and urea (2) were added and the mixture heated to the second temperature and held for a desired period of time. The pH (3) was adjusted with 10% formic acid to a second pH level and held at the second temperature until a desired first viscosity was reached. The pH (4) was adjusted to a third pH as needed and cooled to a third temperature. Urea (5) was added and the reaction mixture held at the third temperature until a desired second viscosity was reached. A pH adjusting agent and water (6) was added while the mixture cooled to a fifth temperature and held for the indicated time. Urea (7) was added and the mixture cooled to a sixth temperature and held 20 minutes. Sodium chloride and sodium sulfate (SodSul) (8) were added and held 10 minutes. The pH was adjusted as needed and cooled to room temperature.

The HMR2 resin composition was obtained and tested. The composition had an observed pH of about 7.9, a refractive index of about 1.462, a specific gravity of about 1.293, a viscosity of about 202 cps, and an oven solids of about 61.18%. The resin composition had a molar ratio of about 1.3 F/(U+M) with a melamine content of about 2.77 wt. %. One embodiment for a combined molar ratio for the LMR2 resin composition and the HMR2 composition is about 0.794 at about 87.5% LMR2 and about 12.5% HMR2.

TABLE 5
HMR2 Component Formulation

| | | | | | Time or |
|---|---|---|---|---|---|
| Step | Component | Quantity % | Temperature | pH | Viscosity |
| 1 | FM (52%) | 46.730 | | | |
| | TEA | 0.50 | | | |
| | Water | 2.000 | 40-60° C. | 7.4-8.0 | |
| 2 | Melamine | 2.770 | | | |
| | Urea | 11.590 | 97-102° C. | | 5 minutes |
| 3 | 30% formic | 0.060 | | | |
| | Water | 0.120 | | 4.9-5.4 | “B” |
| 4 | NaOH (25%) | 0.030 | 75-85° C. | 6.0-6.4 | |
| 5 | Urea | 6.380 | | | “L” |
| 6 | Borax | 0.030 | 65° C. | 7.9-8.3 | |
| | Water | 4.740 | | | |
| 7 | Urea | 18.000 | 40-45° C. | | 20 minutes |
| 8 | Salt | 7.000 | | | |
| | SodSul | 0.500 | 40-45° C. | | 10 minutes |

### Example 3

LMR and HMR Components resins were prepared per the formulations set forth in Tables 6 and 7 below.

A low molar ratio (LMR3) melamine-urea-formaldehyde (MUF) resin composition was prepared using the constituents in Table 6 as described below. The reaction mixture was initiated by (1) mixing formaldehyde with triethanolamine and water at a first temperature, and adjusting to the pH as needed to a first pH. To this reaction mixture, melamine and urea (2) were added and the mixture heated to the second temperature and held for a desired period of time. The pH (3) was adjusted with 10% formic acid to a second pH level and held at the second temperature until a desired first viscosity was reached. The pH (4) was adjusted to a third pH as needed and cooled to a third temperature. Urea (5) was added and the reaction mixture held at the third temperature until a desired second viscosity was reached. A pH adjusting agent, urea and water (6) was added while the mixture cooled to a fifth temperature and held for the indicated time. Urea (7) was added with sodium sulfate and the mixture cooled to a sixth temperature and held 20 minutes. The pH was adjusted as needed and cooled to room temperature.

The LMR3 resin composition was obtained and tested. The composition had an observed pH of about 8.1, a refractive index of about 1.4615, a specific gravity of about 1.255, a viscosity of about 41 cps, and an oven solids of about 60.47%. The resin composition had a molar ratio of about 0.74 F/(U+M) with a melamine content of about 2.77 wt. %.

TABLE 6
LMR3 Component Formulation

| | | | | | Time or |
|---|---|---|---|---|---|
| Step | Component | Quantity % | Temperature | pH | Viscosity |
| 1 | FM (52%) | 36.160 | | | |
| | TEA | 0.50 | | | |
| | Water | 3.410 | 40-60° C. | 7.4-8.0 | |
| 2 | Melamine | 2.770 | | | |
| | Urea | 8.730 | 99-102° C. | | 5 minutes |
| 3 | 30% formic | 0.060 | | | |
| | Water | 0.120 | 99-102° C. | 4.9-5.3 | “C” |
| 4 | NaOH (25%) | 0.040 | 75-85° C. | 6.1-6.5 | |
| 5 | Urea | 7.910 | | | “H” |
| 6 | Borax | 0.050 | 60-65° C. | | |
| | Urea | 6.710 | | | |
| | Water | 6.990 | 60-65° C. | | 20 minutes |
| 7 | Urea | 26.000 | | | |
| | SodSul | 1.000 | 40-45° C. | 7.9-8.3 | 10 minutes |

A high molar ratio (HMR3) melamine-urea-formaldehyde (MUF) resin composition was prepared using the constituents in Table 7 as described below. The reaction mixture was initiated by (1) mixing formaldehyde with triethanolamine and water at a first temperature, and adjusting to the pH as needed to a first pH. To this reaction mixture, melamine and urea (2) were added and the mixture heated to the second temperature and held for a desired period of time. The pH (3) was adjusted with 10% formic acid to a second pH level and held at the second temperature until a desired first viscosity was reached. The pH (4) was adjusted to a third pH as needed and cooled to a third temperature. Urea (5) was added and the reaction mixture held at the third temperature until a desired second viscosity was reached. A pH adjusting agent and water (6) was added while the mixture cooled to a fifth temperature and held for the indicated time. Urea (7) was added and the mixture cooled to a sixth temperature and held 20 minutes. Sodium sulfate (8) was added and held 10 minutes. The pH was adjusted as needed and cooled to room temperature.

The HMR3 resin composition was obtained and tested. The composition had an observed pH of about 8.0, a refractive index of about 1.4615, a specific gravity of about 1.262, a viscosity of about 155 cps, and an oven solids of about 60.65%. The resin composition had a molar ratio of about 1.3 F/(U+M) with a melamine content of about 2.77 wt. %. One embodiment of a combined molar ratio for the LMR3 and the HMR3 resin compositions is about 0.757 at about 96% LMR3 and about 4% HMR3.

TABLE 7
HMR3 Component Formulation

| | | | | | Time or |
|---|---|---|---|---|---|
| Step | Component | Quantity % | Temperature | pH | Viscosity |
| 1 | FM (52%) | 53.080 | | | |
| | TEA | 0.50 | 40-60° C. | 7.4-8.0 | |
| 2 | Melamine | 2.770 | | | |
| | Urea | 13.350 | 97-102° C. | | 5 minutes |
| 3 | 30% formic | 0.060 | | | |
| | Water | 0.120 | 97-102° C. | 4.6-5.0 | “C” |
| 4 | NaOH (25%) | 0.030 | 75-85° C. | 5.9-6.3 | |
| 5 | Urea | 7.240 | | | “M” |
| 6 | Borax | 0.030 | 60-70° C. | 7.8-8.2 | |
| | Water | 2.320 | | | |
| 7 | Urea | 20.450 | 40-45° C. | | 20 minutes |
| 8 | SodSul | 0.500 | 40-45° C. | | 10 minutes |

### Example 4

LMR and HMR Components resins were prepared per the formulations set forth in Tables 8 and 9 below.

A low molar ratio (LMR4) melamine-urea-formaldehyde (MUF) resin composition was prepared using the constituents in Table 8 as described below. The reaction mixture was initiated by (1) mixing formaldehyde with triethanolamine and water at a first temperature, and adjusting to the pH as needed to a first pH. To this reaction mixture, urea (2) was added and the mixture heated to the second temperature and held for a desired period of time. The pH (3) was adjusted with 10% formic acid to a second pH level and held at the second temperature until a desired first viscosity was reached. The pH (4) was adjusted to a third pH as needed and cooled to a third temperature. Melamine and urea (5) was added and the reaction mixture held at the third temperature until a desired second viscosity was reached. Borax and sodium hydroxide (6) were added while the mixture cooled to a fifth temperature and held for the indicated time. Urea (7) was added and the mixture cooled to a sixth temperature and held 20 minutes. The pH was adjusted (8) as needed and cooled to room temperature.

The LMR4 resin composition was obtained and tested. The composition had an observed pH of about 8.7, a refractive index of about 14716, a specific gravity of about 1.2624, a viscosity of about 120 cps, and an oven solids of about 64%. The resin composition had a molar ratio of about 0.738 F/(U+M) with a melamine content of about 3.00 wt. %.

TABLE 8
LMR4 Component Formulation

| | | | | | Time or |
|---|---|---|---|---|---|
| Step | Component | Quantity % | Temperature | pH | Viscosity |
| 1 | FM (52%) | 39.330 | 40-60° C. | 7.4-8.0 | |
| | TEA | 0.050 | | | |
| | Water | 3.235 | | | |
| 2 | Urea | 17.040 | 97-102° C. | | 5 minutes |
| 3 | 10% formic | 0.025 | 97-102° C. | 5.0-5.4 | “H” |
| | water | 0.200 | | | |
| 4 | NaOH (25%) | 0.040 | 75-85° C. | 6.8-7.2 | |
| 5 | Melamine | 3.000 | | | |
| | Urea | 1.990 | | | “P” |
| 6 | Borax | 0.050 | | | |
| | NaOH (25%) | 0.010 | | 8.0-8.4 | |
| 7 | Urea | 34.990 | 40-45° C. | | 20 minutes |
| 8 | NaOH (25%) | 0.040 | | 8.4-8.8 | |

A second composition of a high molar ratio (HMR4) melamine-urea-formaldehyde (MUF) resin composition was prepared using the constituents in Table 9. The reaction mixture was initiated by (1) mixing formaldehyde with triethanolamine and water at a first temperature, and adjusting to the pH as needed to a first pH. To this reaction mixture, melamine and urea (2) were added and the mixture heated to the second temperature and held for a desired period of time. The pH (3) was adjusted with 10% formic acid to a second pH level and held at the second temperature until a desired first viscosity was, reached. The pH (4) was adjusted to a third pH as needed and cooled to a third temperature. Urea (5) was added and the reaction mixture held at the third temperature until a desired second viscosity was reached. A pH adjusting agent (6) was added and water was removed under vacuum while the mixture cooled to a fifth temperature and held for the indicated time. Urea (7) was added and the mixture cooled to a sixth temperature and held 20 minutes. The pH was adjusted as needed and cooled to room temperature.

The HMR4 composition was obtained and tested. The composition had an observed pH of about 8.2, a refractive index of about 1.4742, a specific gravity of about 1.285, a viscosity of about 126 cps, and an oven solids of about 65%. The resin composition had a molar ratio of about 1.3 F/(U+M) with a melamine content of about 3.0 wt. %. One embodiment for a combined molar ratio for the LMR4 and HMR4 compositions is about 0.835 at about 80.2% LMR4 and about 19.8% HMR4. Alternatively, the combined molar ratio for the LMR4 and HMR4 compositions may be about 0.81 at about 85% LMR4 and about 15% HMR4.

TABLE 9
HMR4 Component Formulation

| | | | | | Time or |
|---|---|---|---|---|---|
| Step | Component | Quantity % | Temperature | pH | Viscosity |
| 1 | FM (52%) | 57.520 | | | |
| | TEA | 0.050 | | | |
| | NaOH (25%) | 0.020 | 40-60° C. | 7.4-8.0 | |
| 2 | Melamine | 3.000 | | | |
| | Urea | 14.460 | 97-102° C. | | 5 minutes |
| 3 | 10% formic | 0.035 | | | |
| | water | 0.280 | 97-102° C. | 4.9-5.3 | “C” |
| 4 | NaOH (25%) | 0.070 | 80-85° C. | 6.8-7.2 | |
| 5 | Urea | 7.850 | | | “E+” |
| 6 | Borax | 0.050 | | | |
| | −Vacuum | −5.565 | 60-65° C. | | |
| | Dist | | | | |
| 7 | Urea | 22.230 | 40-45° C. | 8.0-8.4 | 20 minutes |

### Example 5

LMR and HMR Components resins were prepared per the formulations set forth in Tables 10 and 11 below.

A low molar ratio (LMR5) melamine-urea-formaldehyde (MUF) resin composition was prepared using the constituents in Table 10 as described below. The reaction mixture was initiated by (1) mixing formaldehyde with triethanolamine and water at a first temperature, and adjusting to the pH as needed to a first pH. To this reaction mixture, urea (2) was added and the mixture heated to the second temperature and held for a desired period of time. The pH (3) was adjusted with 10% formic acid to a second pH level and held at the second temperature until a desired first viscosity was reached. The pH (4) was adjusted to a third pH as needed and cooled to a third temperature. Melamine and urea (5) was added and the reaction mixture held at the third temperature until a desired second viscosity was reached. Borax and sodium hydroxide (6) were added while the mixture cooled to a fifth temperature and held for the indicated time. Urea (7) was added and the mixture cooled to a sixth temperature and held 20 minutes. The pH was adjusted (8) as needed and cooled to room temperature.

The composition was obtained and tested. The composition had an observed pH of about 8.9, a refractive index of about 1.4717, a specific gravity of about 1.2702, a viscosity of about 132 cps, and an oven solids of about 64.1%. The resin had a molar ratio of about 0.738 F/(U+M) with a melamine content of about 2.00 wt. %.

TABLE 10
LMR5 Component Formulation

| | | | | | Time or |
|---|---|---|---|---|---|
| Step | Component | Quantity % | Temperature | pH | Viscosity |
| 1 | FM (52%) | 40.100 | | | |
| | TEA | 0.050 | | | |
| | Water | 1.935 | | | |
| | NaOH (25%) | 0.010 | 40 60° C. | 7.2-8.2 | |
| 2 | Urea | 17.370 | 97-102° C. | | 5 minutes |
| 3 | 90% formic | 0.025 | | | |
| | water | 0.200 | 97-102° C. | 4.3-4.7 | “J” |
| 4 | NaOH (25%) | 0.040 | 75-85° C. | 6.8-7.2 | |
| 5 | Melamine | 2.000 | | | |
| | Urea | 3.550 | 70-75° C. | | “R” |
| 6 | Borax | 0.050 | | | |
| | NaOH (25%) | 0.010 | | 8.0-8.4 | |
| 7 | Urea | 34.620 | 40-45° C. | | 20 minutes |
| 8 | NaOH (25%) | 0.040 | | 8.5-8.9 | |

A second composition of a high molar ratio (HMR5) melamine-urea-formaldehyde (MUF) resin composition was prepared using the constituents in Table 11. The reaction mixture was initiated by (1) mixing formaldehyde with triethanolamine and water at a first temperature, and adjusting to the pH as needed to a first pH. To this reaction mixture, melamine and urea (2) were added and the mixture heated to the second temperature and held for a desired period of time. The pH (3) was adjusted with 10% formic acid to a second pH level and held at the second temperature until a desired first viscosity was reached. The pH (4) was adjusted to a third pH as needed and cooled to a third temperature. Urea (5) was added and the reaction mixture held at the third temperature until a desired second viscosity was reached. A pH adjusting agent (6) was added and water was removed under vacuum while the mixture cooled to a fifth temperature and held for the indicated time. Urea (7) was added and the mixture cooled to a sixth temperature and held 20 minutes. The pH was adjusted as needed and cooled to room temperature.

The HMR5 resin composition was obtained and tested. The composition had an observed pH of about 8.1, a refractive index of about 1.4739, a specific gravity of about 1.291, a viscosity of about 203 cps, and an oven solids of about 65.1%. The resin composition had a molar ratio of about 1.2 F/(U+M) with a melamine content of about 2.0 wt. %. One embodiment of a combined molar ratio for the LMR5 and HMR5 compositions is about 0.90 at about 61% LMR5 and about 39% HMR5.

TABLE 11
HMR5 Component Formulation

| Component | Quantity % | Temperature | pH | Time or Viscosity |
|---|---|---|---|---|
| FM (52%) | 55.260 | | | |
| TEA | 0.050 | 40-60° C. | 7.2-8.2 | |
| Melamine | 2.000 | | | |
| Urea | 17.860 | 97-102° | | 5 minutes |
| 90% formic | 0.020 | | | |
| water | 0.160 | 97-102° C. | 4.8-5.2 | “B” |
| NaOH (25%) | 0.030 | 85-90° C. | 6.1-6.5 | |
| Urea | 9.770 | 85-90° C. | 6.1-6.5 | I |
| Borax | 0.050 | | | |
| −Vacuum Dist | −4.520 | 50-55° C. | | |
| Urea | 19.320 | 40-45° C. | 8.0-8.4 | 20 minutes |

### Example 6

LMR and HMR Components resins were prepared per the formulations set forth in Tables 12 and 13 below.

A low molar ratio (LMR6) melamine-urea-formaldehyde (MUF) resin composition was prepared using the constituents in Table 12 as described below. The reaction mixture was initiated by (1) mixing UF Concentrate (60% Formaldehyde, 25% Urea), water, and triethanolamine at a first temperature, and adjusting to the pH as needed to a first pH. To this reaction mixture, melamine and urea (2) were added and the mixture heated to the second temperature and held for a desired period of time. The pH (3) was adjusted with 90% formic acid to a second pH level and held at the second temperature until a desired first viscosity was reached. The pH (4) was adjusted to a third pH as needed and cooled to a third temperature. Urea (5) was added and the reaction mixture held at the third temperature until a desired second viscosity was reached. A pH adjusting agent and water (6) were added. Urea (7) was added while the mixture cooled to a fifth temperature and held for the indicated time. Urea (8) was added with sodium sulfate and the mixture cooled to a sixth temperature and held 20 minutes. The pH was adjusted as needed and cooled to room temperature.

The LMR6 resin composition was obtained and tested. The composition had an observed pH of about 8.26, a refractive index of about 1.4638, a specific gravity of about 1.269, a viscosity of about 58 cps, and an oven solids of about 61.35%. The resin had a molar ratio of about 0.738 F/(U+M) with a melamine content of about 2.77 wt. %.

TABLE 12
LMR6 Component Formulation

| | | | | | Time or |
|---|---|---|---|---|---|
| Step | Component | Quantity % | Temperature | pH | Viscosity |
| 1 | UF (85%) | 31.139 | | | |
| | TEA | 0.059 | | | |
| | Water | 16.520 | 40-60° C. | 7.4-8.0 | |
| 2 | Melamine | 2.770 | | | |
| | Urea | 0.884 | 97-102° C. | | 5 minutes |
| 3 | 90% formic | 0.030 | | | |
| | Water | 0.240 | 97-102° C. | 4.8-5.0 | 30 minutes |
| 4 | NaOH (25%) | 0.040 | | | |
| | Water | 3.275 | 90° C. | 6.1-6.3 | |
| 5 | Urea | 7.859 | 80-90° C. | | “K” |
| 6 | Borax | 0.050 | | | |
| | Water | 3.355 | | | |
| 7 | Urea | 6.945 | 65-70° C. | | 20 minutes |
| 8 | Urea | 25.834 | | | |
| | SodSul | 1.000 | 40-45° C. | 8.0-8.4 | 20 minutes |

A second composition of a high molar ratio (HMR6) melamine-urea-formaldehyde (MUF) resin composition was prepared using the constituents in Table 13 as described below. The reaction mixture was initiated by (1) mixing UF Concentrate (60% Formaldehyde, 25% Urea), water, and triethanolamine at a first temperature, and adjusting to the pH as needed to a first pH. To this reaction mixture, urea (2) was added and the mixture heated to the second temperature and held for a desired period of time. The pH (3) was adjusted with 90% formic acid to a second pH level and held at the second temperature until a desired first viscosity was reached. The pH (4) was adjusted to a third pH as needed and cooled to a third temperature. Urea (5) was added with sodium sulfate and the mixture cooled to a sixth temperature and held 20 minutes. The pH was adjusted as needed and cooled to room temperature.

The HMR6 resin composition was obtained and tested. The composition had an observed pH of about 8.0, a refractive index of about 1.4599, a specific gravity of about 1.270, a viscosity of about 233 cps, and an oven solids of about 59.8%. The resin composition had a molar ratio of about 1.13 F/(U+M) with a melamine content of about 2.77 wt. %. One embodiment of a combined molar ratio for the LMR6 and HMR6 resin compositions is about 0.91 at about 55% LMR6 and about 45% HMR6.

TABLE 13
HMR6 Component Formulation without Melamine

| | | | | | Time or |
|---|---|---|---|---|---|
| Step | Component | Quantity % | Temperature | pH | Viscosity |
| 1 | UF (85%) | 42.360 | | | |
| | TEA | 0.047 | | | |
| | Water | 21.985 | 40-60° C. | 7.1-7.5 | |
| 2 | Urea | 16.160 | 99-102° C. | | 5 minutes |
| 3 | 90% formic | 0.010 | 99-102° C. | 5.9-6.1 | “G” |
| | Water | 0.160 | 80-85° C. | | “Q” |
| 4 | NaOH (25%) | 0.040 | 60-65° C. | 7.2-7.6 | |
| 5 | Urea | 18.238 | 50-55° C. | | |
| | SodSul | 1.000 | 40-45° C. | 7.6-8.0 | 20 minutes |

### Example 7

Particle board (PB) panels were manufactured in the laboratory utilizing LMR1 and HMR1 resins as described in Example 1 as well as with CASCO-RESIN Z205 (3% melamine, 0.85 F/(U+M)) and CASCO-RESIN C265NS (2% melamine, 0.95 F/(U+M))) both of which are commercially available from Hexion Specialty Chemicals, Inc. Southern yellow pine core PB furnish was used, targeting 44-45 pcf and a nominal 0.500″ thickness. Resin was applied at about 6% resin solids to oven dry wood and pressed at about 340° F., without catalyst. Two panels per blend were produced, with 30 seconds difference between them. The long cycle was 30 seconds to close to thickness, 105 seconds hold at thickness, and 15 seconds decompression. The short cycle was identical to the long cycle with regard to closing time and decompression, but with a 75 second hold at thickness.

Seven different resin blends were utilized as set forth in Table 14. The panels were made from the lowest applied molar ratio to the highest to avoid contamination of residual material skewing the emission results. Graphs of the IB, density and emissions for each cycle are set forth in FIGS. 1 to 4.

TABLE 14
Resin Blends

| Blend | 1 | 2 | 3 | 4 | 5 | 6 | 7 |
|---|---|---|---|---|---|---|---|
| Resin 1% | LMR | LMR | Z205 | LMR | LMR | C265NS | HMR |
| | 100% | 88.5% | 100% | 77% | 58% | 100% | 100% |
| Resin 2% | | HMR | | HMR | HMR | | |
| | | 11.5% | | 23% | 42% | | |
| Applied MR | 0.74 | 0.79 | 0.85 | 0.85 | 0.95 | 0.95 | 1.30 |

The data in FIGS. 1-4 was performed as follows. Internal Bond testing was done in accordance to ASTM D1037-1999, tensile strength perpendicular to the surface. Formaldehyde testing was done in the small scale chambers at Advanced Testing Services (ATS) in Springfield, Oreg. per ASTM D6007-02(2008)

Referring to FIGS. 1 and 2, at the long cycle, the LMR component alone produced a panel equivalent to the panels produced from the resins with systems up to 0.95 molar ratios. Additionally, the panels formed with the combined LMR component and HMR component had formaldehyde emissions of less than about 0.2 ppm, such as from about 0.068 ppm to about 0.163, which was a noticeable improvement over boards made with only the HMR component, about 0.634 ppm or greater. Additionally, as shown in FIG. 1, the LMR and HMR component panels exhibited similar densities with improved internal bond strength, i.e., greater than 61.5 psi (68.1 psi to 75.7 psi) for the long cycle, and greater than 26.4 psi (34.7 psi to 46.2 psi), in comparison to the LMR component only panel.

Referring to FIG. 3, at the long cycle, the IB results cannot be discriminated from this data for any of the samples with the exception of the last blend, at about 1.30 mole ratio. This condition was significantly higher for both the long and short cycles and was essentially the same at both cycles.

Referring to FIG. 4, the formaldehyde results show significant reduction in the emissions from the high molar ratio to the lower molar ratios. There was no difference in emissions when comparing results of the same mole ratio with the exception of the 0.95 mole ratio setting. It is believed that the difference in melamine amounts could explain the differences in emissions observed at that mole ratio. The emissions show a flattening of the impact of lower molar ratio. As the molar ratio is reduced further, there is less of a change in the emission results.

It is believed that the two component system provides for more definite control of the respective amounts of the amino compounds and formaldehyde in the panels as well as a more definite control of panel properties, such as formaldehyde emissions and IB strength and MOR values, while providing substantially equivalent densities and other physical properties as compared to currently formed panels.

### Example 8

Particle board (PB) panels were manufactured in the laboratory utilizing LMR2, HMR2, LMR3 and HMR3 resins as described in Examples 2 and 3 as well as with CASCO-RESIN™ Z205S (3% melamine, 0.85 F/(U+M)), CASCO-RESIN™ F-TD46, CASCO-RESIN™ C-TD51 (1.17 F/U resins designed for surface and core PB), and CASCO-RESIN™ XL-2000 (0.33 F/U scavenger resin) all of which are commercially available from Hexion Specialty Chemicals, Inc.

The PB panels were made with three layer construction, which is comprised of two surface layers surrounding a core layer. The two surface layers have one target molar ratio and the core layers containing a different target molar ratio.

The panels were made to have about a 0.625″ thickness and a 44 pcf density. The resin was applied at different loading rates (dosing) in the surface layers, about 7.6% and about 10.2%, as compared to the core layer, about 5% and about 6.8%. The about 7.6% surface layer was paired with the about 5% core layer for a low dosing level and the about 10.2% surface layer was paired with the about 6.8% core layer for a high dosing level.

The panels were also made with each resin system targeting a surface layer molar ratios, about 0.80 and about 0.76, different from the core layer molar ratios, about 0.85 and about 0.80. The about 0.80 surface layer was paired with the about 0.85 core layer for the high molar ratio setting and the about 0.76 surface layer was paired with the about 0.80 core layer for the low molar ratio setting. Different mixes of resin and scavenger were used for the control system and the LMR/HMR systems to achieve the target molar ratios as shown in Table 15. The resin components for all systems were mixed and then immediately applied to the wood particles to form the respective layers.

TABLE 15

| | | Surface Layer | | Core Layer | |
|---|---|---|---|---|---|
| | | Molar Ratio | | Molar Ratio | |
| System | Resins | 0.80 | 0.76 | 0.85 | 0.76 |
| Control | Casco-Resin ™ | 61% | 56% | | |
| System 1 | F-TD46 | | | | |
| | Casco-Resin ™ | | | 68% | 62% |
| | C-TD51 | | | | |
| | Casco-Resin ™ | 39% | 44% | 32% | 38% |
| | XL-2000 | | | | |
| Control | Casco-Resin ™ | 92% | 85% | 100% | 92% |
| System 2 | Z205S | | | | |
| | Casco-Resin ™ | 8% | 15% | 0 | 8% |
| | XL-2000 | | | | |
| Experimental | LMR2 | 86% | 95% | 75% | 86% |
| System 1 | HMR2 | 14% | 5% | 25% | 14% |
| Experimental | LMR3 | 87% | 96% | 77% | 87% |
| System 2 | HMR3 | 13% | 4% | 23% | 13% |

The panels were made to have 60% of the total panel weight was from the core layer and the remaining 40% of the total panel weight was split evenly between the top surface layer and the bottom surface layer.

The panels were made by pressing the respective layers using a press temperature of about 345° F. (about 174° C.). Each combination of the described resin systems, dosing level, and molar ratio, was pressed at two different press cycles, short and long. The short cycle included time durations of about 30 seconds to close, about 135 seconds at the target thickness, and about 40 seconds decompression. The long cycle included time durations 30 seconds to close, 185 seconds at target thickness, and 40 seconds decompression.

Referring to FIG. 5, the internal bond (IB) results indicated equivalent to improved performance of 50 psi or greater for both experimental systems when compared to the control systems. Internal Bond testing was done in accordance to ASTM D1037-1999, tensile strength perpendicular to the surface.

Referring to FIG. 6, modulus of rupture (MOR) results also indicated equivalent performance among all of the various systems. MOR testing was done in accordance to ASTM D1037-1999, static bending test. Due to limitations of the panel size produced, the specimen width and length and test span were modified from the prescribed dimensions in the standard method for the specimen thickness. All samples were treated the same and the modifications included in the MOR calculation. The results can not be compared to results obtained with standard dimensions, but they can all be compared to each other.

Referring to FIG. 7, formaldehyde emissions show that both experimental systems had lower emissions than the control systems at the same target molar ratios. Formaldehyde testing was done in the small scale chambers at Advanced Testing Services (ATS) in Springfield, Oreg. per ASTM D6007-02(2008).

The combination of improved to equivalent physical properties at lower formaldehyde emissions are a desirable result and demonstrate the efficiency of the experimental system.

The LMR and HMR compositions of Example 4 were used to form medium density fiberboard (MDF) boards as described herein and compared with more conventional low emitting resin systems (low mole ratio resin combined with scavenger resin to achieve target emissions). Trial results showed equal to improved property and emission results with the new system and improved performance with regard to sensitivity to fiber moisture content, resulting in fewer press blows or delaminations.

In the MDF 12 mm board production, the control condition used a single composition of about 0.835 MR to form the MUF resin in a core layer sandwiched between two surface layers made with a single composition of about 0.803 MR to form the MUF resin. The trial compositions, as disclosed in Example 4 above, used a combined composition of about 80.8% LMR and about 19.2% HMR providing a core layer having a about 0.83 MR and surface layers made using about 85% LMR and about 15% HMR for a about 0.81 MR.

Results from 2 different press cycles at the same dosing levels showed that the trial condition had improved internal bonds and better emission results, though all met the target level. At the baseline press cycle trial internal bonds were 110.5% higher and emissions were 34.7% lower (control press cycle was longer by 6.3% than the trial for the baseline). Reducing the cycle time by 5.5% for the trial resin and 12.5% for the control to get to the same cycle time, the trial internal bonds were 122.5% higher and emissions were 9.6% lower.

While the present invention has been described and illustrated by reference to particular embodiments, those of ordinary skill in the art will appreciate that the invention lends itself to variations not necessarily illustrated herein.

What is claimed is:

1. A resin system, comprising:
a first amino-formaldehyde resin comprising formaldehyde, urea, and melamine and having a first molar ratio of formaldehyde to urea and melamine; and
a second amino-formaldehyde resin comprising at least formaldehyde and urea and having a second molar ratio of formaldehyde to urea, wherein the second molar ratio is greater than the first molar ratio and a combined molar ratio of formaldehyde to urea and melamine of the resin system comprises from about 0.6 to about 1.24.

2. The resin system of claim 1, wherein the first molar ratio comprises from about 0.6 to about 0.85, and the second molar ratio comprises from about 1.05 to about 1.4.

3. The resin system of claim 3, wherein the second amino-formaldehyde resin comprises formaldehyde, urea, and melamine, and further comprises a second molar ratio of formaldehyde to urea and melamine from about 1.05 to about 1.4.

4. The resin system of claim 1, wherein the first amino-formaldehyde resin comprises from about 99.9 parts to about 30 parts and the second amino-formaldehyde resin comprises from about 70 parts to about 0.1 parts based on weight of the resin system, with the total parts based on weight of the first and second amino-formaldehyde resins comprising 100 parts.

5. The resin system of claim 1, wherein at least one of the first amino-formaldehyde resin and the second amino-formaldehyde resin comprises melamine and the melamine content of the resin system is from about 0.2 parts to about 7 parts based on weight.

6. The resin system of claim 5, wherein the first amino-formaldehyde resin comprises a melamine content from about 0.75 parts to about 7 parts based on weight and the second amino-formaldehyde resin comprises a melamine from about 0 parts to about 7 parts based on weight.

7. An article of manufacture, comprising:
a resin system comprising:
a first amino-formaldehyde resin comprising formaldehyde, urea, and melamine and having a first molar ratio of formaldehyde to urea and melamine; and
a second amino-formaldehyde resin comprising at least formaldehyde and urea and having a second molar ratio of formaldehyde to urea, wherein the second molar ratio is greater than the first molar ratio and the combined molar ratio of formaldehyde to urea and melamine of the resin system comprises from about 0.6 to about 1.24; and
a cellulosic material component.

8. The article of manufacture of claim 7, wherein the first molar ratio comprises from about 0.6 to about 0.85, and the second molar ratio comprises from about 1.05 to about 1.4.

9. The article of manufacture of claim 8, wherein the second amino-formaldehyde resin comprises formaldehyde, urea, and melamine and further comprises a ratio of formaldehyde to urea and melamine from about 1.05 to about 1.4.

10. The article of manufacture of claim 7, wherein the first amino-formaldehyde resin comprises from about 99 parts to about 30 parts and the second amino-formaldehyde resin comprises from about 70 parts to about 1 parts based on weight of the resin system, with the total parts based on weight of the first and second amino-formaldehyde resins comprising 100 parts.

11. The article of manufacture of claim 7, wherein at least one of the first amino-formaldehyde resin and the second amino-formaldehyde resin comprise melamine and the melamine content of the resin system comprises from about 0.2 parts to about 7 parts based on weight.

12. The article of manufacture of claim 10, wherein the first amino-formaldehyde resin comprises a melamine content from about 0.75 parts to about 7 parts based on weight and the second amino-formaldehyde resin comprises a melamine content from about 0 parts to about 7 parts based on weight.

13. The article of manufacture of claim 7, wherein the resin system comprises from about 5 wt. % to about 20 wt. % of the article of manufacture.

14. The article of manufacture of claim 7, wherein the cellulosic material comprises a material selected from the group consisting of wood particles, wood strands, wood fibers, wood veneers, and combinations thereof.

15. The article of manufacture of claim 7, wherein the article of manufacture comprises a panel structure having one or more layers and is selected from the group consisting of a particleboard, hardwood plywood, a medium density fiberboard, and combinations thereof.

16. The article of manufacture of claim 15, wherein the article of manufacture comprises a core layer and at least one surface layer disposed on the core layer, and wherein the core layer comprises a first resin system having a first molar ratio and the at least one surface layer comprises a second resin system having a second molar ratio less than the first molar ratio.

17. The article of manufacture of claim 7, wherein the article of manufacture has a free formaldehyde emission from about 0.04 ppm to about 0.3 ppm at a resin system molar ratio from about 0.6 to about 1.24.

18. A process for forming a resin system, comprising:
providing a first amino-formaldehyde resin comprising formaldehyde, urea, and melamine to a mixing apparatus;
providing a second amino-formaldehyde resin comprising at least formaldehyde and urea to the mixing apparatus, wherein the second molar ratio is greater than the first molar ratio; and
mixing the first amino-formaldehyde resin and the second amino-formaldehyde resin, wherein a combined molar ratio of formaldehyde to urea and melamine of the resin system comprises from about 0.6 to about 1.24.

19. The process of claim 18, wherein the first molar ratio comprises from about 0.6 to about 0.85, and the second molar ratio comprises from about 1.05 to about 1.4.

20. The process of claim 19, wherein the second amino-formaldehyde resin comprises formaldehyde, urea, and melamine and further comprises a ratio of formaldehyde to urea and melamine from about 1.05 to about 1.4.

21. The process of claim 18, wherein the first amino-formaldehyde resin comprises from about 99 to about 30 parts and the second amino-formaldehyde resin comprises from about 70 to about 1 parts based on weight of the resin system, with the total parts based on weight of the first and second amino-formaldehyde resin comprising 100 parts.

22. The process of claim 18, wherein at least one of the first amino-formaldehyde resin and the second amino-formaldehyde resin comprise melamine and the melamine content of the resin system is from about 0.2 to about 7 parts based on weight.

23. The process system of claim 22, wherein the first amino-formaldehyde resin comprises a melamine content from about 0.75 to about 7 parts based on weight and the second amino-formaldehyde resin comprises a melamine from about 0 to about 7 parts based on weight.

24. The process of claim 18, further comprising contacting the resin system with a cellulosic material component to form an article of manufacture.

25. The process of claim 24, wherein the cellulosic material comprises a material selected from the group consisting of wood particles, wood strands, wood fibers, wood veneers, and combinations thereof.

26. The process of claim 24, wherein the resin system comprises from about 5 wt. % to about 20 wt. % of the article of manufacture.
